(19) United States
(12) Patent Application Publication
(10) Pub. No.: US 2024/0069900 A1
(43) Pub. Date: Feb. 29, 2024

(54) SERVER, SOFTWARE UPDATE SYSTEM, AND SOFTWARE UPDATE METHOD

(71) Applicant: TOYOTA JIDOSHA KABUSHIKI KAISHA, Toyota-shi (JP)

(72) Inventors: Tomoyasu ISHIKAWA, Nagoya-shi (JP); Hiroshi INOUE, Nagoya-shi (JP); Shunsuke TANIMORI, Arlington, VA (US); Nana KIKUIRE, Toyota-shi (JP)

(73) Assignee: TOYOTA JIDOSHA KABUSHIKI KAISHA, Toyota-shi (JP)

(21) Appl. No.: 18/364,594

(22) Filed: Aug. 3, 2023

(30) Foreign Application Priority Data
Aug. 29, 2022 (JP) 2022-136054

(51) Int. Cl. G06F 8/65

(52) U.S. Cl. CPC G06F 8/65

(57) ABSTRACT

A server determines whether a vehicle is being driven. The server sends a notification, requesting a user of the vehicle to approve processing related to a software update of a control device installed in the vehicle. When the server determines that the vehicle is being driven, the server sends the notification to an in-vehicle terminal mounted on the vehicle. When the server determines that the vehicle is not being driven, the server sends the notification to a mobile terminal portable by the user of the vehicle.

### CROSS-REFERENCE TO RELATED APPLICATION

This application claims priority to Japanese Patent Application No. 2022-136054 filed on Aug. 29, 2022, incorporated herein by reference in its entirety.

### BACKGROUND

### 1. Technical Field

The present disclosure relates to a server, a software update system, a software update method, and a non-transitory storage medium.

### 2. Description of Related Art

Japanese Unexamined Patent Application Publication No. 2017-149323 (JP 2017-149323 A) discloses a technique for updating software of a control device installed in a vehicle over the air (OTA).

### SUMMARY

A server described in JP 2017-149323 A notifies a smartphone of a request for approval of a software update, and upon receiving a reply of approval from the smartphone, executes downloading of new software (updated version of the software). The smartphone corresponds to a terminal (hereinafter also referred to as a “mobile terminal”) that can be carried by a user of a vehicle.

However, a mobile terminal is not necessarily the best human machine interface (HMI) to receive the notification. For example, when the smartphone receives the notification while a user is driving a vehicle, the user may misunderstand communication (approval request) regarding the software update as communication (for example, emergency communication) regarding other requirements. Such misunderstandings may negatively affect the user's ability to drive. On the other hand, when the HMI that receives the notification is limited to a terminal (hereinafter also referred to as an “in-vehicle terminal”) mounted on the vehicle, if the user is not in the vehicle, the notification (approval request) regarding the software update cannot be received, resulting in inconvenience for the user.

The present disclosure provides a server, a software update system, and a software update method that suppress software update notifications that could hinder the driving of a vehicle, while ensuring that the user receives sufficient convenience.

A first aspect of the present disclosure relates to a server including a one or more processor. The one or more processor configured to: determine whether a vehicle is being driven; and send a notification requesting a user of the vehicle to approve processing related to a software update of a control device installed in the vehicle. The one or more processor is configured to, when the vehicle is being driven, send the notification to an in-vehicle terminal mounted on the vehicle. The one or more processor is configured to, when the vehicle is not being driven, send the notification to a mobile terminal portable by the user.

With the configuration described above, the notification (notification of approval request) can be made to the in-vehicle terminal while the vehicle is being driven. Therefore, the user can recognize that the notification pertains to a software update by checking the in-vehicle terminal, which has received the campaign notification, without the need to check the mobile terminal of the user. As a result, the user is less likely to experience any obstacles to driving the vehicle. Examples of the in-vehicle terminal include a meter panel, a navigation system, and a head-up display. Also, the server notifies (notification of approval request) the mobile terminal when the vehicle is not being driven. This makes it easier to ensure sufficient user convenience.

In the first aspect, when the vehicle is being driven, one or more processor may not be configured to send the notification to the mobile terminal.

With the configuration described above, the mobile terminal does not receive the above-described notification (notification of approval request) while the vehicle is being driven. This prevents the user while driving from misunderstanding communication (approval request) regarding a software update as communication (for example, emergency communication) regarding other requirements.

In the first aspect, when the vehicle is not being driven, the one or more processor may be configured to send the notification not only to the mobile terminal but also to the in-vehicle terminal.

With the configuration described above, the user can receive the above-described notification through both the in-vehicle terminal and the mobile terminal while the vehicle is not being driven. This improves user convenience.

In the first aspect, the one or more processor may be configured to determine that the vehicle is not being driven when the mobile terminal is located outside the vehicle.

With the configuration described above, it becomes easier to easily and appropriately determine whether the vehicle is being driven. Then, when the user of the vehicle is not in the vehicle, the mobile terminal can receive the above-described notification (approval request).

A second aspect of the present disclosure relates to a software update system including an in-vehicle terminal, a mobile terminal, and a server including one or more processor. The in-vehicle terminal is mounted on a vehicle. The mobile terminal is portable by a user of the vehicle. The one or more processor of the server is configured to send a notification, requesting the user to approve processing related to a software update of a control device installed in the vehicle. The server is configured to send the notification to the in-vehicle terminal when the vehicle is being driven. The one or more processor of the server is configured to send the notification to the mobile terminal when the vehicle is not being driven.

With the configuration described above, similar to the above-described server, with respect to the software update, it is possible to suppress the software update notification hindering the driving of the vehicle, while still ensuring sufficient user convenience.

In the second aspect, the one or more processor of the server may be configured to send the notification not only to the in-vehicle terminal but also to the mobile terminal when the vehicle is being driven. When the mobile terminal receives the notification from the one or more processor of the server while the vehicle is being driven, the mobile terminal may be configured to notify the user of the vehicle of the software update by voice.

With the configuration described above, when the mobile terminal receives the above-described notification (notification of approval request) while the vehicle is being driven, it notifies the user of the software update by voice. Therefore, the user while driving is less likely to misunderstand communication (approval request) regarding the software update as the communication (for example, emergency communication) regarding other requirements.

In the second aspect, when each of the in-vehicle terminal and the mobile terminal receives the notification from the one or more processor of the server, each of the in-vehicle terminal and the mobile terminal may be configured to display a message that prompts the user of the vehicle to perform an operation indicating whether the user approves or rejects the notification. Each of the in-vehicle terminal and the mobile terminal may be configured to send a reply indicating approval to the one or more processor of the server when the operation indicating approval is performed by the user.

With the configuration described above, it is possible for the user to easily and appropriately send a reply indicating approval to the server.

A third aspect of the present disclosure relates to a software update method performed by one or more processor including determining whether a vehicle is being driven, sending a notification to an in-vehicle terminal mounted on the vehicle, requesting a user of the vehicle to approve processing related to a software update of a control device installed in the vehicle when a server determines that the vehicle is being driven, and sending the notification to a mobile terminal portable by the user of the vehicle when the server determines that the vehicle is not being driven.

With the configuration described above, similar to the above-described server, with respect to the software update, it is possible to suppress that software update notification hindering the driving of the vehicle, while still ensuring sufficient user convenience.

With each aspect of the present disclosure, with respect to the software update, it is possible to suppress that software update notification hindering the driving of the vehicle, while still ensuring sufficient user convenience.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram for illustrating a configuration of a software update system according to an embodiment of the present disclosure;

FIG. 2 is a diagram for illustrating an overview of a software update method according to the embodiment of the present disclosure;

FIG. 3 is a diagram for illustrating an approval request in the software update method according to the embodiment of the present disclosure;

FIG. 4 is a flow chart for illustrating a process procedure of the software update method according to the embodiment of the present disclosure; and

FIG. 5 is a diagram for illustrating a modification example of processes illustrated in FIG. 4.

### DETAILED DESCRIPTION OF EMBODIMENTS

An embodiment of the present disclosure will be described in detail with reference to the drawings. In the drawings, the same or corresponding parts are denoted by the same reference numerals, and the description thereof will not be repeated.

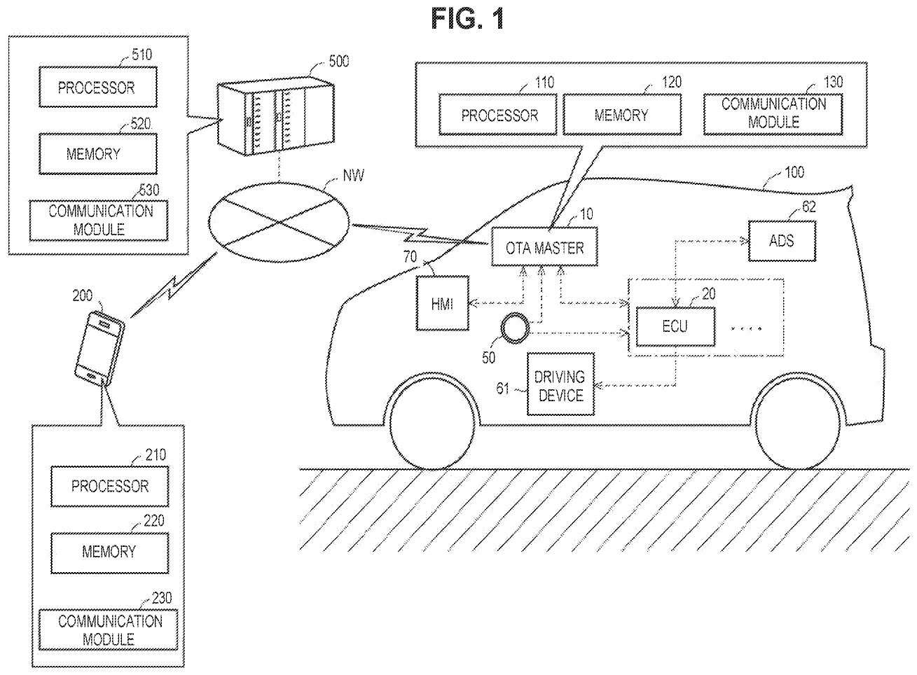

FIG. 1 is a diagram for illustrating a configuration of a software update system according to this embodiment. Referring to FIG. 1, this software update system includes a vehicle 100, a mobile terminal 200, and an OTA center 500.

The vehicle 100 is, for example, an electric vehicle (BEV) without an internal combustion engine. The vehicle 100 includes an OTA master 10, a plurality of ECUs (only ECU 20 is illustrated), an activation switch 50, a driving device 61, an autonomous driving system (ADS) 62, and a human machine interface (HMI) 70. The OTA master 10, the ECUs, the driving device 61, the ADS 62, and the HMI 70 are each supplied with power from a power source (for example, a vehicle battery) not illustrated. “ECU” means Electronic Control Unit. “OTA” is an abbreviation for “Over The Air”.

The activation switch 50 is a switch for a user to activate the vehicle system (the control system of the vehicle 100), and is installed in a cabin of the vehicle 100, for example. The activation switch is generally called a “power switch” or an “ignition switch”. When the user operates the activation switch 50, the vehicle system is switched between on (operation) and off (stop). When the activation switch 50 is turned on, the vehicle system (including OTA master 10 and ECU 20) in a stopped state is started, and the vehicle system enters an operating state (hereinafter also referred to as “IG ON”). Further, when the activation switch 50 is turned off while the vehicle system is operating, the vehicle system enters a stopped state (hereinafter also referred to as “IG OFF”).

An ON operation of the activation switch 50 is an operation for switching the state of the vehicle 100 from IG OFF to IG ON. When the user turns on the activation switch 50, a start request is inputted to each of the OTA master 10 and the ECUs. That is, each of the OTA master 10 and the ECUs receives an activation request from the user. On the other hand, an OFF operation of the activation switch 50 is an operation for switching the state of vehicle 100 from IG ON to IG OFF. When the user turns off the activation switch 50, a shutdown request is input to each of the OTA master 10 and the ECUs. That is, each of the OTA master 10 and the ECUs approves a shutdown request from the user. However, in the vehicle 100 that is traveling, turning off the activation switch 50 is prohibited.

The HMI 70 includes an input device and a display device. The HMI 70 may include a touch panel display that functions as an input device and a display device. The HMI 70 may include an information display or a telltale as a display device. The HMI 70 may include a steering switch as an input device. At least one of an in-vehicle infotainment (IVI) system, a meter panel, and a head-up display may function as the HMI 70.

The OTA center 500 is a server that provides a vehicle software update service using OTA technology. The OTA center 500 is configured to perform in-vehicle ECU software updates remotely from the center via a communication section. The OTA master 10 manages in-vehicle information, receives campaigns, and manages software update sequences. The OTA master 10 has a computer incorporated therein and functions as an in-vehicle diagnostic device. The OTA master 10 controls each ECU having an OTA function. In the vehicle 100, the OTA master 10 and the ECU 20 each have an OTA function. Although not illustrated in FIG. 1, the vehicle 100 includes an ECU having an OTA function in addition to the ECU 20. The vehicle 100 may further include an ECU (not illustrated) that does not have an OTA function. The OTA master 10 and each ECU are connected via a communication bus and configured to be able to communicate with each other by wire. The communication method is not particularly limited, but may be controller area network (CAN) or Ethernet (registered trademark), for example. Each ECU (ECU 20 and the like) installed in the vehicle 100 incorporates a computer including at least one processor and at least one memory. Each ECU may include a plurality of microcomputers in the form of a main microcomputer and a sub-microcomputer. The number of ECUs that are included in the vehicle 100 is arbitrary.

The vehicle 100 is an autonomous driving vehicle that is configured to be capable of autonomous driving. The vehicle 100 according to this embodiment is configured to be capable of both manned and unmanned travel. The vehicle 100 is configured to be unmanned and capable of autonomous travel, but can also be manually made to travel (manned travel) by a user. The vehicle 100 can also perform autonomous driving (for example, cruise control) during manned travel. The level of autonomous driving may be fully automated driving (level 5) or conditional automated driving (for example, level 4).

The ECU 20 is configured to control the driving device 61. The driving device 61 includes an accelerator device, a braking device, and a steering device. The accelerator device includes, for example, a motor generator (hereinafter referred to as “MG”) that rotates driving wheels of the vehicle 100, a power control unit (PCU) that drives the MG, and a battery that supplies power to the PCU to drive the MG. The MG functions as a traveling motor for the vehicle 100. The braking device includes, for example, a braking device provided on each wheel of the vehicle 100 and an actuator that drives the braking device. The steering system includes, for example, an electric power steering (EPS) and an actuator that drives the EPS.

The ADS 62 includes a recognition sensor (for example, at least one of a camera, a millimeter wave radar, and a lidar) that recognizes the external environment of the vehicle 100, and executes processes related to autonomous driving based on information that is sequentially acquired by the recognition sensor. Specifically, the ADS 62, in cooperation with the ECU 20, generates a travel plan (information indicating future behavior of the vehicle 100) according to the external environment of the vehicle 100. Then, the ADS 62 requests the ECU 20 to control various actuators in the driving device 61 so that the vehicle 100 travels according to the travel plan.

In this embodiment, the ADS 62 has been integrated into the vehicle 100. However, the ADS 62 is not limited to this, and may be an autonomous driving kit that is detachable from the vehicle 100. A sensor unit (including the recognition sensor) of the autonomous driving kit may be attached to a rooftop of the vehicle 100.

The mobile terminal 200 is configured to be portable by the user of vehicle 100. In this embodiment, a smart phone equipped with a touch panel display is adopted as the mobile terminal 200. A smart phone incorporates a computer and has a speaker function. However, the mobile terminal 200 is not limited to a smart phone, and any terminal that can be carried by the user of the vehicle 100 can be adopted. For example, a laptop, a tablet terminal, a portable game machine, or a wearable device (smart watch, smart glasses, smart glove, or the like) can also be used as the mobile terminal 200.

The mobile terminal 200 is installed with application software (hereinafter referred to as “mobile application”) for using the services provided by the OTA center 500. Identification information (terminal ID) of the mobile terminal 200 is linked to identification information (vehicle ID) of the vehicle 100 and registered in the OTA center 500 by the mobile application. The mobile terminal 200 can exchange information with the OTA center 500 through the mobile application. The mobile terminal 200 may function as an electronic key that remotely locks and unlocks doors of the vehicle 100. Also, the mobile terminal 200 may play a similar role as the activation switch 50. The mobile terminal 200 may remotely switch the state (IG ON/IG OFF) of the vehicle system according to the user's operation (ON operation/OFF operation). With such mobile terminal 200, the user can switch the state of the vehicle system even when the user is outside the vehicle.

The OTA master 10 includes a processor 110, a memory 120, and a communication module 130. The mobile terminal 200 includes a processor 210, a memory 220, and a communication module 230. The OTA center 500 includes a processor 510, a memory 520, and a communication module 530. Each of the processors 110, 210, and 510 includes, for example, a central processing unit (CPU). Each of the memories 120, 220, and 520 includes a non-volatile memory, such as a flash memory, or a non-transitory storage medium.

The communication module 130 is configured to communicate with devices outside the vehicle. The communication module 130 may include a telematics control unit (TCU) and/or a data communication module (DCM) for wireless communication. Further, the communication module 130 may include a communication I/F (interface) that performs wired communication with a device outside the vehicle. The OTA master 10 may communicate by wire with a scan tool (dedicated tool for wire software update) via a data link connector (DLC) (not illustrated).

Each of the communication modules 130, 230 accesses communication network NW by wireless communication. The communication module 530 is connected to the communication network NW by wire, and communicates with each of a plurality of vehicles (including the vehicle 100) and each of a plurality of mobile terminals (including the mobile terminal 200) via the communication network NW. The communication network NW is, for example, a wide area network constructed by the Internet and wireless base stations. The communication network NW may include a mobile phone network. Each of the OTA master 10 and the mobile terminal 200 communicates with the OTA center 500 by wireless communication. The OTA master 10, the mobile terminal 200, and the OTA center 500 communicate with each other via the communication network NW.

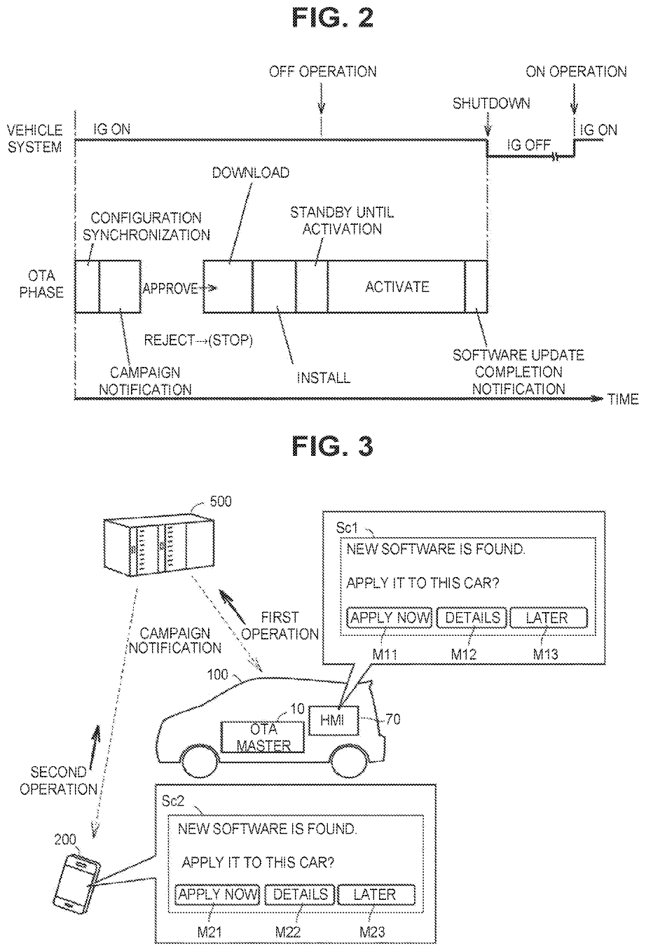

FIG. 2 is a diagram for illustrating an overview of a software update method according to this embodiment. Referring to FIG. 2 together with FIG. 1, processes related to a software update (more specifically, a vehicle software update using OTA) are performed by procedures such as configuration synchronization, campaign notification and application approval, download, installation, activation, and software update completion notification.

The vehicle 100 in the IG ON state repeatedly performs configuration synchronization every time a preset time period (for example, one hour) elapses. A configuration synchronization process by the vehicle 100 includes sending vehicle configuration information to the OTA center 500. The vehicle configuration information includes, for example, hardware information (information indicating hardware product numbers, ECU identifiers, and the like) and software information (information indicating software product numbers, and the like) for each ECU in the vehicle 100. The vehicle configuration information may further include RXSWIN for each authorization target. RXSWIN is an identification number that can specify the software that forms the functional type approval.

When the OTA center 500 receives the vehicle configuration information from the vehicle 100, the OTA center 500 checks the currently occurring campaign (software update). Then, when there is a campaign applicable to the vehicle 100, the OTA center 500 sends an approval request signal requesting the user of the vehicle 100 to approve the download of new software (update version of software) related to the campaign. The approval request signal includes information (campaign information) on the campaign. The campaign information may include, for example, at least one of pieces of campaign attribute information (information indicating the purpose of the software update and vehicle functions that may be affected by the update), a list of campaign target vehicles, information (for example, software information before and after updating) on campaign target ECUs, and information on notifications to users before and after updating. The campaign to be notified may be a newly generated campaign or a campaign that was not applied before. In the following, the transmission of the approval request signal is also referred to as “campaign notification”.

FIG. 3 is a diagram for illustrating a campaign notification (approval request) in the software update method according to this embodiment. In this embodiment, the OTA master 10 and the HMI 70 mounted on the vehicle 100 cooperate to function as an example of an “in-vehicle terminal” according to the present disclosure.

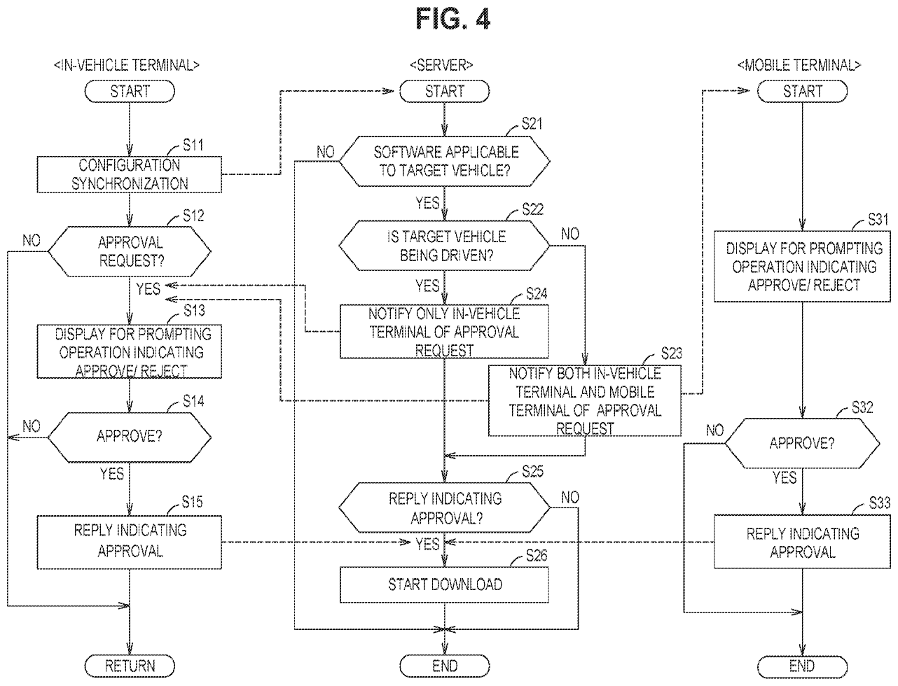

Referring to FIG. 3, the OTA center 500 determines whether the vehicle 100 is being driven before sending the campaign notification. Details of a determination method will be described below (see S22 in FIG. 4). Then, when the OTA center 500 determines that the vehicle 100 is being driven, the OTA center 500 notifies the OTA master 10 of the campaign. On the other hand, when the OTA center 500 that the vehicle 100 is not being driven, the OTA center 500 notifies both the OTA master 10 and the mobile terminal 200 of the campaign. Each of the OTA master 10 and the mobile terminal 200 that have received the campaign notification prompts the user to approve or reject the campaign notification (approval request signal). Then, each of the OTA master 10 and the mobile terminal 200 sends a reply indicating approval to the OTA center 500 when the user performs an operation indicating approval.

Specifically, when the OTA master 10 receives the campaign notification, the HMI 70 displays a screen Sc1. When the mobile terminal 200 receives the campaign notification, the mobile terminal 200 notifies the user of the incoming call by sound or vibration, and the touch panel display of the mobile terminal 200 displays a screen Sc2. Each of the screens Sc1, Sc2 displays a message such as “New software is found. Apply it to this car?” asking the user to perform an operation indicating whether to approve the download of the new software.

The screens Sc1 includes an apply button M11 for approving an “approve” operation, a confirm button M12, and a non-apply button M13 for approving a “reject” operation. The screens Sc2 includes an apply button M21 for approving an “approve” operation, a confirm button M22, and a non-apply button M23 for approving a “reject” operation. When the apply button M11 is operated, the OTA master 10 replies “approve” to the OTA center 500. When the non-apply button M13 is operated, the OTA master 10 erases the display of the screen Sc1 without replying “approve”. Hereinafter, operating either the apply button M11 or the non-apply button M13 on the screen Sc1 will be referred to as a “first operation”. On the other hand, when the apply button M21 is operated on the screen Sc2, the mobile terminal 200 replies “approve” to the OTA center 500. When the non-apply button M23 is operated, the mobile terminal 200 erases the display of the screen Sc2 without replying “approve”. Hereinafter, operating either the apply button M21 or the non-apply button M23 on the screen Sc2 will be referred to as a “second operation”. Each of the first operation and the second operation indicates the user's intention (approval/refusal) for the campaign notification (approval request).

When the confirmation button M12 or M22 is operated before the first operation or the second operation described above is performed, the HMI 70 or the mobile terminal 200 display the content of the campaign (at least part of the campaign information). Therefore, the user can determine whether to approve the download of new software related to the campaign after grasping the content of the campaign.

Although the details will be described below, when the OTA center 500 according to this embodiment receives the reply of “approve” from the OTA master 10 or the mobile terminal 200, the OTA center 500 shifts the process related to software update to a download phase. On the other hand, when the OTA center 500 does not receive the reply of “approve” from the OTA master 10 or the mobile terminal 200, the OTA center 500 terminates the process related to software update without proceeding to the download phase.

Referring to FIG. 2 together with FIG. 1 again, the OTA center 500 and the vehicle 100 execute the process related to download, for example, in the procedure described below. Hereinafter, the terminal (in-vehicle terminal or mobile terminal 200) that has sent the above-described “approve” will be referred to as an “approval terminal”.

The OTA master 10 requests a distribution package containing new software from the OTA center 500. Then, the OTA master 10 downloads (receives and stores) the distribution package while performing wireless communication with the OTA center 500. The distribution package may include package attribute information (information indicating the update category, the number of update data in the delivery package, the installation order of each ECU, and the like) and update data attribute information (identifier of a target ECU, verification data for verifying the correctness of the update data, and the like) in addition to new software (for example, a set of update data for each ECU as a target of the campaign). The target ECU is an ECU as a software update target. For example, the target ECU may be the ECU 20, and the software to be updated may be an autonomous driving control program.

The distribution package is stored in a storage device (for example, memory 120) provided in the OTA master 10 by the process related to the download described above. During the download, the approval terminal notifies the user of the progress of the download. After completing the download, the OTA master 10 verifies authenticity of the downloaded distribution package. Then, when a verification result is “normal”, the OTA master 10 notifies the OTA center 500 of a software update status (download complete). This notification means that the download was successful.

When the download is successful, the vehicle 100 will perform the installation. Specifically, the OTA master 10 requests at least one target ECU (for example, the ECU 20) to output a state of the target ECU and a diagnostic trouble code (DTC). The OTA master 10 determines whether installation can be executed for each target ECU based on the state of the target ECU and the DTC. The OTA master 10 then transfers the new software (update data) to the target ECU that can execute installation. The target ECU that has received the update data installs (writes the update data to the non-volatile memory) the update data. During the installation, the approval terminal informs the user of the progress of the installation.

When the transfer of the update data from the OTA master 10 to the target ECU is completed, the target ECU sends a transfer completion notification to the OTA master 10. Then, the OTA master 10 that has received the transfer completion notification requests integrity verification from the target ECU. The target ECU that receives this request performs verification using integrity verification data (verification data) and sends a verification result to the OTA master 10. The OTA master 10 stores the verification result (installation completion/failure/cancellation) for each target ECU. When the integrity verification of all target ECUs is completed and all verification results are “normal”, the OTA master 10 notifies the OTA center 500 of the software update status (installation completed). This notification means that the installation was successful.

When the installation is successful following the download, the vehicle 100 enters a standby state and will remain in that state until it is activated. Thereafter, when a turn-off operation is performed on the activation switch 50 or the mobile terminal 200, the OTA master 10 causes the approval terminal to display a predetermined message and requests the user to input either “approve” or “reject”. Then, when the user makes an input indicating “approve” to the approval terminal, the OTA master 10 activates the software (validates the installed software). On the other hand, when the user makes an input indicating “reject” to the approval terminal, the OTA master 10 stops the process related to the software update without executing activation, and the vehicle system is shut down.

The OTA master 10 displays the result of the software update on the approval terminal when the configuration confirmation after activation is completed is successful. The approval terminal displays, for example, a software update complete screen indicating that the update was successful. Then, the OTA master 10 notifies the OTA center 500 of the software update status (software update completed). This notification means that the OTA software update was successful. When this notification is given, the control system of the vehicle 100 is shut down and the IG is turned off. Then, when a turn-on operation is performed on the activation switch 50 or the mobile terminal 200, the vehicle system turns on the IG. This activates the update program (new version software) in the target ECU.

FIG. 4 is a flow chart for illustrating a process procedure of the software update method according to this embodiment. “S” in the flow chart means step. A series of processes from S11 to S15 are executed by the OTA master 10 (in-vehicle terminal), a series of processes from S21 to S26 are executed by the OTA center 500 (server), and a series of processes from S31 to S33 are executed by the mobile terminal 200. The following flow chart is realized by one or more processors reading and executing programs stored in one or more memories. In this embodiment, the processor 510 illustrated in FIG. 1 functions as an example of a “determination unit” and a “notification unit” according to the present disclosure.

Referring to FIG. 4 together with FIGS. 1 to 3, in S11, the OTA master 10 performs configuration synchronization. Specifically, the OTA master 10 transmits the above-described vehicle configuration information to the OTA center 500. Subsequently, the OTA master 10 determines in S12 whether the OTA master has received a campaign notification.

When the OTA center 500 receives the vehicle configuration information, the OTA center 500 starts the series of processes from S21 to S26. In S21, the OTA center 500 determines whether there is a campaign (new or unapplied software update) applicable to the target vehicle from which the vehicle configuration information has been sent. The target vehicle here is the vehicle 100 illustrated in FIG. 1. When there is no campaign applicable to the vehicle 100 (NO in S21), the series of processes from S21 to S26 are terminated.

When there is a campaign applicable to the vehicle 100 (YES in S21), the OTA center 500 determines whether the vehicle 100 is being driven in S22. For example, when the mobile terminal 200 is located inside the vehicle 100 (in the vehicle cabin), the OTA center 500 determines that the vehicle 100 is being driven. On the other hand, when the mobile terminal 200 is located outside the vehicle 100 (outside the vehicle), the OTA center 500 determines that the vehicle 100 is not being driven. The OTA center 500 may, for example, receive location information from each of the vehicle 100 and the mobile terminal 200 and determine whether the mobile terminal 200 exists outside the vehicle 100 based on the location information. Alternatively, the OTA center 500 may receive a signal from the mobile terminal 200 indicating whether the mobile terminal 200 exists in the vehicle 100 and determine whether the terminal 200 exists outside the vehicle 100 based on the signal.

The method of determining whether the vehicle 100 is being driven is not limited to the above. For example, the OTA center 500 may receive a signal from vehicle 100 indicating whether the vehicle 100 is being driven, and determine whether the vehicle 100 is being driven on the basis of the signal. The OTA master 10 may determine that the vehicle 100 is being driven when the activation switch 50 is turned on, and may determine that the vehicle 100 is no longer driving when the IG state is switched from IG ON to IG OFF. A sensor (for example, a seat belt sensor or a seat sensor) for detecting a driver may be provided in the driver's seat of the vehicle 100. The OTA master 10 may determine that the vehicle 100 is being driven when there is a driver in the driver's seat, and that the vehicle 100 is not being driven when there is no driver in the driver's seat. Alternatively, the OTA center 500 may determine that the vehicle 100 is being driven when the vehicle 100 is traveling. The OTA center 500 may receive signals from the vehicle 100 indicating the position and/or state (for example, vehicle speed) of the vehicle 100 and determine whether the vehicle 100 is traveling on the basis of the signals.

When the OTA center 500 determines that the vehicle 100 is not being driven (NO in S22), in S23, the OTA center 500 notifies each of the OTA master 10 and the mobile terminal 200 of the campaign notification requesting the user of the vehicle 100 to approve the download of the new software related to the campaign. On the other hand, when the OTA center 500 determines that the vehicle 100 is being driven (YES in S22), the OTA center 500 notifies only the OTA master 10 of the campaign notification in S24. After executing the processes of S23 or S24, the OTA center 500 determines in S25 whether the OTA center 500 has received a reply of “approve” from the in-vehicle terminal (OTA master 10) or the mobile terminal 200.

When the OTA master 10 receives the campaign notification (S23, S24) from the OTA center 500 within a predetermined period (for example, a period from configuration synchronization until a predetermined time elapses), the OTA master 10 determines YES in S12. In this case, the process proceeds to S13. On the other hand, when the OTA master 10 does not receive the campaign notification within the predetermined period after the configuration synchronization, the OTA master 10 determines NO in S12, and the series of processes of S11 to S15 are terminated. A determination of NO in S12 means that there is no campaign applicable to the vehicle 100. After the series of processes of S11 to S15 ends, when a preset time has elapsed since previous configuration synchronization, the series of processes of S11 to S15 is started again, and configuration synchronization (S11) is executed.

In S13, the OTA master 10 causes the HMI 70 to display a message that prompts the user of the vehicle 100 to perform an operation indicating whether the user approves or rejects the campaign notification. Specifically, the OTA master 10 controls the HMI 70 so that the HMI 70 displays the screen Sc1 illustrated in FIG. 3.

In S14, the OTA master 10 determines whether the apply button M11 (FIG. 3) has been operated by the user. When the HMI 70 displays the screen Sc1 (FIG. 3) and a predetermined time has elapsed without the user operating the apply button M11, the OTA master 10 determines NO in S14 and erases the display of the screen Sc1 by the HMI 70. In this case, the series of processes from S11 to S15 are terminated without replying “approve”. On the other hand, when the user operates the apply button M11 before the predetermined time elapses after the HMI 70 displays the screen Sc1 (FIG. 3), the OTA master 10 determines YES in S14 and advances the process to S15. In S15, the OTA master 10 replies “approve” to the OTA center 500. Then, when the process of S15 is executed, the series of processes of S11 to S15 is completed.

When the mobile terminal 200 receives the campaign notification (S23) from the OTA center 500, the mobile terminal 200 starts a series of processes from S31 to S33. In S31, the mobile terminal 200 displays a display that prompts the user of the vehicle 100 to perform an operation indicating whether the user approves or rejects the campaign notification. Specifically, the mobile terminal 200 (touch panel display) displays the screen Sc2 illustrated in FIG. 3.

In S32, the mobile terminal 200 determines whether the apply button M21 (FIG. 3) has been operated by the user. When the mobile terminal 200 displays the screen Sc2 (FIG. 3) and a predetermined time has elapsed without the user operating the apply button M21, the mobile terminal 200 determines NO in S32 and erases the display of the screen Sc2. In this case, the series of processes from S31 to S33 are terminated without replying “approve”. On the other hand, when the user operates the apply button M21 before the predetermined time elapses after the mobile terminal 200 displays the screen Sc2 (FIG. 3), the mobile terminal 200 determines YES in S32 and advances the process to S33. In S33, the mobile terminal 200 replies “approve” to the OTA center 500. Then, when the process of S33 is executed, the series of processes of S31 to S33 ends.

When the OTA center 500 receives a reply of “approve” (S15, S33) from the in-vehicle terminal (OTA master 10) or the mobile terminal 200, the OTA center 500 determines YES in S25. Specifically, the OTA center 500 approves the reply of “approve” during a predetermined reception period (for example, a period from when the campaign is notified until a predetermined time elapses). Then, when the approval period has elapsed without receiving a reply of “approve” from either the in-vehicle terminal or the mobile terminal 200, the OTA center 500 determines NO in S25. In this case, the OTA center 500 terminates the series of processes from S21 to S26 without advancing the process related to software update to the download phase. On the other hand, when the OTA center 500 receives a reply of “approve” (S15, S33) from the in-vehicle terminal or the mobile terminal 200 within the reception period (YES in S25), the OTA center 500 advances the process related to software update to the download phase in S26. This initiates the download of new software related to the campaign. When the process of S26 is executed, the series of processes of S21 to S26 ends. The processes after the start of downloading have already been described (see FIG. 2).

As described above, the software update method according to this embodiment includes the processes illustrated in FIG. 4. That is, the software update method includes the OTA center 500 determining whether the vehicle 100 is being driven (S22), the OTA center 500 notifying the in-vehicle terminal (OTA master 10) mounted on the vehicle 100 of the campaign (S24) when the OTA center 500 determines that the vehicle 100 is being driven (YES in S22), and the OTA center 500 notifying the mobile terminal 200 portable by the user of the vehicle 100 of the campaign (S23) when the OTA center 500 determines that the vehicle 100 is not being driven (NO in S22). The campaign notification requests the user of the vehicle 100 to approve the process related to updating the software of the ECU (control device) installed in the vehicle 100.

According to the method described above, while the user is driving the vehicle 100, the campaign notification is sent to the in-vehicle terminal (OTA master 10). Therefore, the user who is driving can recognize that the notification pertains to a software update by checking the in-vehicle terminal (HMI 70), which has received the campaign notification, without the need to check the mobile terminal 200 of the user. As a result, the user is less likely to experience any obstacles to driving the vehicle 100. Also, when the user is not driving the vehicle 100, the campaign notification is sent to the mobile terminal 200. Therefore, the user who is not driving can grasp the content of the campaign notification by checking the mobile terminal 200 that has received the campaign notification without checking the in-vehicle terminal. This makes it easier to ensure sufficient user convenience.

The processes illustrated in FIG. 4 can be changed as appropriate. For example, in the processes illustrated in FIG. 4, when the OTA center 500 determines that the vehicle 100 is not being driven (NO in S22), the OTA center 500 notifies not only the mobile terminal 200 but also the in-vehicle terminal (OTA master 10) (S23). Therefore, the user can check the campaign notification through both the in-vehicle terminal (HMI 70) and the mobile terminal 200 when the vehicle 100 is not being driven. However, the process of S23 may be changed so that the OTA center 500 notifies only the mobile terminal 200 of the campaign.

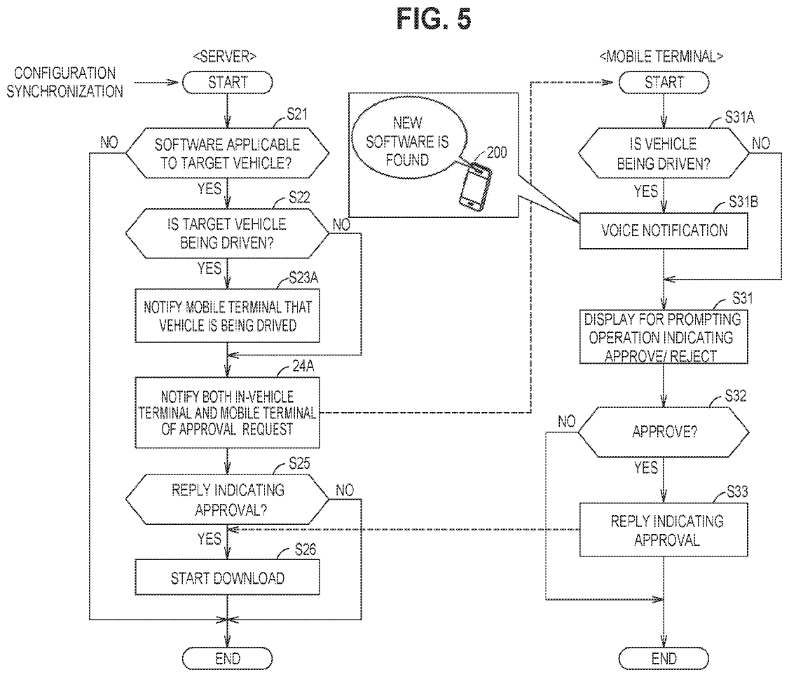

Further, in the processes illustrated in FIG. 4, when the OTA center 500 determines that the vehicle 100 is being driven (YES in S22), the OTA center 500 does not notify the mobile terminal 200 of the campaign. This prevents the user while driving from misunderstanding the communication (approval request) regarding the software update as the communication (for example, emergency communication) regarding other requirements. However, the campaign is not limited to this, and a campaign notification may be sent to the mobile terminal 200 when it is determined that the vehicle 100 is being driven. For example, instead of S21 to S26 and S31 to S33 illustrated in FIG. 4, processes illustrated in FIG. 5 described below may be adopted.

FIG. 5 is a diagram for illustrating a modification example of the processes illustrated in FIG. 4. Although not illustrated in FIG. 5, the series of processes from S11 to S15 illustrated in FIG. 4 are executed by the OTA master 10 (vehicle terminal) also in this modification example.

Referring to FIG. 5 together with FIGS. 1 to 3, in this modification example, S23A and S24A are adopted instead of S23 and S24 in FIG. 4. When the OTA center 500 determines that the vehicle 100 is being driven (YES in S22), the process proceeds to S24A after the process of S23A is performed. When the OTA center 500 determines that the vehicle 100 is not being driven (NO in S22), the process proceeds to S24A without performing the process of S23A. In S23A, the OTA center 500 sends a signal (hereinafter referred to as “in-driving signal”) indicating that the vehicle 100 is being driven to the mobile terminal 200. This in-driving signal informs the mobile terminal 200 that the vehicle 100 is being driven. In S24A, the OTA center 500 notifies each of the OTA master 10 and the mobile terminal 200 of the campaign, similar to S23 of FIG. 4. Then, the process proceeds to S25. The subsequent processes are the same as the example illustrated in FIG. 4.

Upon receiving the campaign notification (S24A) from the OTA center 500, the mobile terminal 200 starts a series of processes (S31A, S31B, S31 to S33) illustrated in FIG. 5. In this modification example, S31A and S31B are added before S31 to S33 illustrated in FIG. 4. In S31A, the mobile terminal 200 determines whether the vehicle 100 is being driven. The mobile terminal 200 determines whether the vehicle 100 is being driven based on whether the in-driving signal (S23A) is received from the OTA center 500. When the mobile terminal 200 determines that the vehicle 100 is being driven (YES in S31A), the process proceeds to S31 after the process of S31B is performed. When the mobile terminal 200 determines that the vehicle 100 is not being driven (NO in S31A), the process proceeds to S31 without performing the process of S31B. In S31B, the mobile terminal 200 notifies the user of the software update by voice through a speaker. The mobile terminal 200 may audibly announce a message such as, for example, “New software is found.” The processing after S31 is the same as the example illustrated in FIG. 4.

In the software update system according to the above-described modification example, when the vehicle 100 is being driven (YES in S22), the OTA center 500 notifies not only the in-vehicle terminal but also the mobile terminal 200 of the campaign (S24A). Then, when the mobile terminal 200 receives the campaign notification from the OTA center 500 while the vehicle 100 is being driven (YES in S31A), it notifies the user of the vehicle 100 of the software update by voice (S31B). This could reduce the risk of the user while driving mistaking the update (approval request) for other requirements (for example, urgent communication).

In the embodiment described above, an on-premises server is adopted as the OTA center 500 (see FIG. 1). However, an applicable embodiment of the present disclosure is not limited to this, and functions (for example, functions related to software update) of the OTA center 500 may be implemented on the cloud by cloud computing. That is, the OTA center 500 may be a cloud server. The software to be updated is not limited to a driving support system control program such as the autonomous driving control program described above, and can be applied to any applicable software. It is not essential that the vehicle is configured to be autonomously drivable.

The vehicle may be xEV (electric vehicle) other than BEV. The vehicle may be a plug-in hybrid vehicle (PHEV) or hybrid vehicle (HEV) with an internal combustion engine (for example, a gasoline engine, a biofuel engine, or a hydrogen engine). The vehicle is not limited to a four-wheeled passenger car, but may be a bus, a truck, or a three-wheeled xEV. The in-vehicle battery may be configured to be contact chargeable, may be configured to be non-contact chargeable (wireless charge) while the vehicle is parked or traveling, or may be configured to be replaceable. The vehicle may have solar panels. The vehicle may have flight capabilities. The vehicle may be a mobility as a service (MaaS) vehicle. A MaaS vehicle is a vehicle managed by a MaaS provider. The vehicle may be a multi-purpose vehicle that is customized according to the user's purpose of use. The vehicle may be a mobile shop vehicle, a robotaxi, an automated guided vehicle (AGV), or an agricultural machine. The vehicle may be an unmanned or single-person compact BEV (for example, a last mile BEV or a power wheelchair).

The various modification examples described above may be combined appropriately and implemented.

The embodiment disclosed this time should be considered as an example and not restrictive in all respects. The scope of the present disclosure n is indicated by the scope of the summary rather than the description of the above-described embodiment, and is intended to include all modifications within the scope and meaning equivalent to the scope of the summary.

What is claimed is:

1. A server comprising a one or more processor configured to:
determine whether a vehicle is being driven; and
send a notification requesting a user of the vehicle to approve processing related to a software update of a control device installed in the vehicle, wherein:
the one or more processor is configured to, when the vehicle is being driven, send the notification to an in-vehicle terminal mounted on the vehicle; and
the one or more processor is configured to, when the vehicle is not being driven, send the notification to a mobile terminal portable by the user.

2. The server according to claim 1, wherein the one or more processor is configured not to, when the vehicle is being driven, send the notification to the mobile terminal.

3. The server according to claim 2, wherein the one or more processor is configured to, when the vehicle is not being driven, send the notification not only to the mobile terminal but also to the in-vehicle terminal.

4. The server according to claim 1, wherein the one or more processor is configured to determine that the vehicle is not being driven when the mobile terminal is located outside the vehicle.

5. A software update system comprising:
an in-vehicle terminal mounted on a vehicle;
a mobile terminal portable by a user of the vehicle; and
a server including one or more processor configured to send a notification requesting the user to approve processing related to a software update of a control device installed in the vehicle, wherein:
the one or more processor of the server is configured to send the notification to the in-vehicle terminal when the vehicle is being driven; and
the one or more processor of the server is configured to send the notification to the mobile terminal when the vehicle is not being driven.

6. The software update system according to claim 5, wherein:
the one or more processor of the server is configured to send the notification not only to the in-vehicle terminal but also to the mobile terminal when the vehicle is being driven; and
when the mobile terminal receives the notification from the one or more processor of the server while the vehicle is being driven, the mobile terminal is configured to notify the user of the software update by voice.

7. The software update system according to claim 5, wherein:
when each of the in-vehicle terminal and the mobile terminal receives the notification from the one or more processor of the server, each of the in-vehicle terminal and the mobile terminal is configured to display a message that prompts the user to perform an operation indicating whether the user approves or rejects the notification; and
each of the in-vehicle terminal and the mobile terminal sends a reply indicating approval to the one or more processor of the server when the operation indicating approval is performed by the user.

8. A software update method performed by one or more processor comprising:
Determining, by the one or more processor, whether a vehicle is being driven;
sending, by the one or more processor, a notification to an in-vehicle terminal mounted on the vehicle, requesting a user of the vehicle to approve processing related to a software update of a control device installed in the vehicle when a server determines that the vehicle is being driven; and
sending, by the one or more processor, the notification to a mobile terminal portable by the user when the server determines that the vehicle is not being driven.

9. A non-transitory storage medium storing instructions that are executable by one or more processors and that cause the one or more processors to perform functions characterized by comprising:
determining whether the vehicle is being driven;
sending a notification to an in-vehicle terminal mounted on the vehicle, requesting a user of the vehicle to approve processing related to a software update of a control device installed in the vehicle when a server determines that the vehicle is being driven; and
sending the notification to a mobile terminal portable by the user when the server determines that the vehicle is not being driven.
